(19) United States
(12) Patent Application Publication
(10) Pub. No.: US 2003/0094294 A1
(43) Pub. Date: May 22, 2003

(54) Hand grip for an electrical hand tool

(76) Inventor: Gerold Fritz, Feldkirch (AT)

Correspondence Address: David Toren, SIDLEY AUSTIN BROWN & WOOD LLP, 787 Seventh Avenue, New York, NY, 10019, US

(21) Appl. No.: 10/295,385

(22) Filed: Nov. 15, 2002

(30) Foreign Application Priority Data
Nov. 19, 2001 (EP) 01811107.0

(51) Int. Cl. B27C 3/08

(52) U.S. Cl. 173/171; 173/217

(57) ABSTRACT

A hand grip for an electrical hand tool (1) includes a tool receptacle (2) arranged at the leading end of the tool housing (3) and a radially outwardly projecting hand grip (4) fixed to its trailing end, the hand grip (4) of the tool housing (3) is part of a guard part (6) formed by an auxiliary hand grip (6) spaces ahead of the hand grip (4) and axially fixed connected to the tool housing (3).

### BACKGROUND OF THE INVENTION

The invention relates to a hand grip for an electrical hand tool such as a drill, a hammer drill, a screwing drill, and the like which can be advantageously operated using a battery power pack.

This type of electrical hand tool, which extends along a longitudinally extending tool axis, has at its leading end a tool receptacle or chuck that is driven by an electrical drive and at its trailing end a hand grip projecting radially from the axis of the tool, which contains conventional control elements and is used principally for application of axial forces by the tool operator. As disclosed in U.S. Pat. No. 5,881,823, for example, there is optionally, a second hand grip projecting radially from the longitudinal axis of the tool that is mounted so as to be rotationally pivoted and whose purpose is to absorb torque.

A T-shaped hand grip offset to the axial center is, for example, disclosed in U.S. Pat. No. 6,168,881, and is suitable by virtue of its axially central center of gravity, and thus minimal hand moment, for predominantly horizontal operation of the electrical hand tool, as opposed to a terminally arranged pistol grip, for example as disclosed in U.S. Pat. No. 5,343,691, which is suitable for predominantly vertical operation of the electrical hand tool.

Powerpack driven electrical hand tools, for example as disclosed in U.S. Pat. No. 4,871,629, have a heavy storage battery that is usually arranged in a radially outer end zone of the hand grip so as to achieve a high rotational moment of inertia. Due to the high mass of the storage battery, the hand grip construction must be attached with sufficient stability relative to the rest of the tool housing, which involves additional technical support.

DE2917475 discloses an electrical hand tool having at its trailing end along its longitudinal tool axis a closed stirrup-shaped hand grip with a control element.

U.S. Pat. No. 6,813,805 discloses an electrical hand tool having a closed stirrup-shaped grip running along the longitudinal axis of the tool. The stirrup-shaped grip does not form a hand grip projecting radially from the tool's longitudinal axis but forms a hand grip that is arranged along the longitudinal axis of the tool.

According to DE19745308A1, a drill is disclosed having a pistol-like hand grip projecting radially from the longitudinal axis of the tool and a second, auxiliary hand grip projecting radially from the longitudinal axis of the tool and which is shielded axially forwardly by an open bowlike guard.

According to EP878272, the hand grip projecting radially from the longitudinal axis of the tool together with a motor housing projecting radially from the longitudinal axis of the tool and arranged axially forwardly forms a closed guard part, wherein the motor housing is too extensive to accommodate an auxiliary hand grip.

According to DE3224141, a hand grip projecting radially from the longitudinal axis of the tool has a closed guard part whose configuration is too thin for an auxiliary hand grip and is spaced too closely to the hand grip for two-handed operation.

### SUMMARY OF THE INVENTION

The primary object of the invention is to provide a compact and technically simple, two-handed hand grip design for an electrical hand tool. Another object of the invention is the stabile connection of the storage battery housing with the tool housing.

Essentially an electrical hand tool that runs along a longitudinal tool axis comprises at its leading end a tool receptacle or chuck that is driven by an electrical drive and has at its trailing end a hand grip region projecting radially outwardly from the longitudinal axis of the tool and fixed on the tool housing. The hand grip conventionally accommodates control elements and serves principally in the application of axial force by the tool operator, whereby arranged forwardly of the hand grip is an auxiliary hand grip fixed to the tool housing and forming a guard part extending from the hand grip to the tool housing.

Through the arrangement of the auxiliary hand grip as a closed guard part, a desirable attachment of the hand grip to the housing results, whereby particularly the flexural torque generated by the axial forces can be satisfactorily absorbed.

Advantageously an optionally removable storage battery housing is arranged on the radially outer part of the closed guard part, thereby resulting in high torsional moment of inertia as well as a stabile fixation of the storage battery housing.

In a preferred arrangement the radially outer part of the closed guard part can be formed solely by the battery housing, which accordingly is bilaterally, optionally detachably, fixed in the closed guard part, whereby a mains operated electrical hand tool with two axially spaced, hand grips each projecting radially outwardly from the longitudinal axis of the tool forms a closed guard part with the supplementally mounted battery housing.

Advantageously, the radially outwardly arranged surface of the battery housing is configured as an optionally slip-resistant, rubber-coated stand for the electrical hand tool, whereby the high mass of the storage battery is used to advantage as a stabile arrangement of the mass center of gravity of the electrical hand tool located over the stand.

Further, advantageously the hand grip and the auxiliary hand grip have a circumferentially extending surface in the range of 10 cm to 15 cm that can be easily gripped and advantageously molded to fit the hand.

Preferably, the hand grip and / or the auxiliary hand grip are covered with a slip-resistant and vibration-damping material such as rubber.

### BRIEF DESCRIPTION OF THE DRAWING

The invention will now be more completely described using two advantageous exemplary embodiments read together where:

FIG. 1 is a side elevational view of a hand grip for an electrical hand tool, and

FIG. 2 is a partial view of a detail of a variation of the hand grip in FIG. 1.

### DETAILED DESCRIPTION OF THE INVENTION

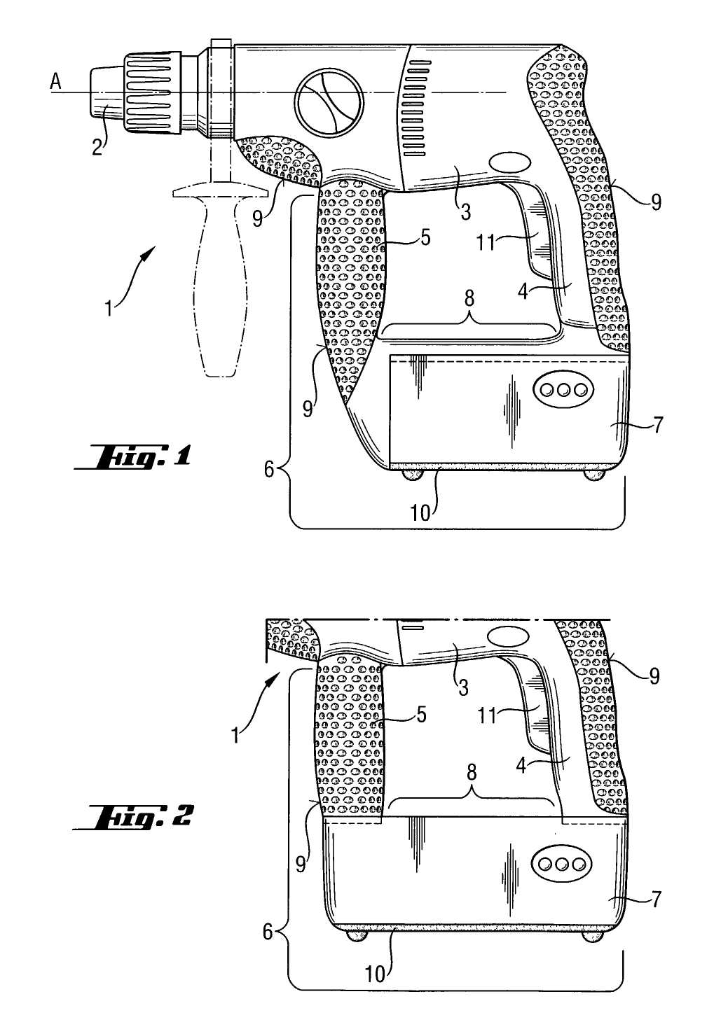

According to FIG. 1, an electrical hand tool 1 extending along a longitudinal tool axis, has at its leading end a tool receptacle or chuck 2 and at a trailing end a hand grip 4 fixed to the tool housing 3 and projecting radially downwardly from the longitudinal axis A of the tool as viewed on FIG. 1. The hand grip has a main switch 11 as a control element, with an auxiliary hand grip 5 arranged axially forwardly and fixed to the tool housing 3 and forming a closed guard part 6 extending from the hand grip 4 to the tool housing 3. A storage battery housing 7 extends in the axial direction and is removable from behind and is in form locked engagement on the radially outer guard part section 8 of the closed guard part 6. The hand grip 4 and the auxiliary hand grip 5 have a manually grippable circumferentially extending surface and are ergonomically molded to fit the operator's hand and are partially covered with rubber.

In the variation shown in FIG. 2, the radially outer guard part section of the closed guard part 6 is formed exclusively by the battery housing which can be securely but removably mounted at both ends and accordingly is securely incorporated in the closed guard part 6. The radially outer surface of the battery housing 7 is shaped as a rubber covered pedestal 10 for the electrical hand tool.

What is claimed is:

1. A hand grip for an electrical hand tool (1) comprising an axially extending tool housing (3), said housing (3) having an axis (A) extending between a leading end and a trailing end with a tool receptacle (2) at the leading end, a hand grip (4) extending radially outwardly at and fixed to a trailing end region of said housing and a guard part (6) extending radially outwardly of the trailing end region and forming an auxiliary hand grip (5) spaced in the axially extending direction toward said leading end from said hand grip (4) and extending radially outwardly from said tool housing (3), a guard part section (8) spaced radially outwardly from said tool housing (3) and connected to and extending between an end of said auxiliary hand grip (5) spaced outwardly from said tool housing (3) and an end of said hand grip (4) spaced outwardly from said tool housing (3), and said tool housing (3) and hand grip (4), said auxiliary hand grip (5) and said guard part section forming a closed space open laterally in the axial direction between said hand grip (4) and said auxiliary hand grip (5).

2. A hand grip, as set forth in claim 1, wherein a storage battery housing (7) secured in said guard part section (8) of said guard part (6).

3. A hand grip, as set forth in claim 1, wherein said guard part section (8) is formed completely by a storage battery housing (7) extending between and secured to the ends of said hand grip (4) and said auxiliary hand grip (5) spaced radially outwardly from said tool housing (3).

4. A hand grip, as set forth in claim 2, wherein the radially outer surface of said battery housing (7) is formed of a pedestal (10) for said electrical hand tool (1).

5. A hand grip, as set forth in claim 4, wherein said pedestal (10) is formed of a slip-resistant covering.

6. A hand grip, as set forth in claim 3, wherein the radially outer surface of said battery housing (7) is formed of a pedestal (10) for said electrical hand tool (1).

7. A hand grip, as set forth in claim 6, where said pedestal (10) is formed of a slip-resistant covering.

8. A hand grip, as set forth in claim 1, wherein said hand grip (4) and said auxiliary hand grip (5) each has a circumferentially extending gripping surface in the range of 10 cm to 15 cm

9. A hand grip, as set forth in claim 1, wherein at least one of said hand grip (4) and said auxiliary hand grip (5) are at least partially covered with slip-resistant and vibration damping material (9).

10. A hand grip, as set forth in claim 9, wherein said slip resistant and vibration damping material (9) is rubber.
